(19) United States
(12) Patent Application Publication
(10) Pub. No.: US 2009/0145187 A1
(43) Pub. Date: Jun. 11, 2009

(54) Electric operator control unit

(75) Inventors: Werner Deppner, Ingolstadt (DE); Wolfgang Thiel, Denkendorf (DE)

Correspondence Address: FASSE PATENT ATTORNEYS, P.A., P.O. BOX 726, HAMPDEN, ME, 04444-0726, US

(73) Assignee: Conti Temic microelectronic GmbH, Nuernberg (DE)

(21) Appl. No.: 12/227,800

(22) PCT Filed: Aug. 9, 2007
(86) PCT No.: PCT/DE2007/001419

§ 371 Date: Nov. 26, 2008

(30) Foreign Application Priority Data
Sep. 29, 2006 (DE) 10 2006 046 801.5
Sep. 29, 2006 (DE) 10 2006 046 802.3

(51) Int. Cl. E05B 19/00

(52) U.S. Cl. 70/448

(57) ABSTRACT

An electrical operating unit for a motor vehicle with a shaft for retaining an emergency key is described, wherein the emergency key is movably arranged in the shaft between a storage position and a usage position. A locking mechanism is provided for locking the emergency key and the movable battery compartment lid.

As a locking mechanism, the battery compartment lid itself or a locking element which is mechanically connected to it is provided, and the battery compartment lid is movable into a position as a result of which the emergency key can be locked in the usage position and/or the storage position. The movement of the battery compartment lid is used to move the battery compartment lid or a locking element which is formed on it between the locking and unlocking position.

The invention relates to an electrical operating unit with a shaft for retaining an emergency key, wherein the emergency key is kept in the operating unit, and can be pulled out as required. Operating units of this type are known for example as the ignition key or radio remote control operation unit for the central locking system of a motor vehicle.

Alongside the embodiments with a separate, removable emergency key (ref. e.g. DE 19943498 A1), embodiments with an emergency key which is attached to the operating unit are also known (ref. e.g. DE 4238042 A1), in which the emergency key can be pushed or pivoted into the usage position.

DE 102004026164 A1 shows an embodiment in which the emergency key is located in a key housing in a shaft, through which it is guided when being pulled in and out. When being pulled out, the emergency key is pulled into a usage position. In order to prevent it from being pushed back into the shaft while being used, measures must be taken. For this purpose, with DE 102004026164 A1, a button is provided on the emergency key which interacts with corresponding fastening openings, and when the button is activated, said button can be pushed out of the fastening opening in each case, and the emergency key can be moved. A button of this type is structurally complex.

Electrical operating units of this type generally have a battery as an electrical energy supply, which is arranged in a battery compartment in such a manner that it can be replaced. The battery compartment and the emergency key shaft increase the construction space required, however. In order to protect it from humidity, the battery compartment must be closed by means of a detachable battery compartment lid. However, as a result, there is a risk of loss of the battery compartment lid.

The object of the invention is therefore to provide an operating unit with an emergency key in which the emergency key can during usage be secured against being pushed back into the shaft. Furthermore, an embodiment of an operating unit with an emergency key shaft and a battery compartment should be provided in which a space-saving division layout is guaranteed, and a battery compartment lid for a battery compartment is secured in a particularly simple manner against being lost.

This object is attained by means of the features described in the independent claims. Advantageous further embodiments are described in the sub-claims.

The key is pushed back according to the invention through the battery compartment lid, or is obstructed by a locking element which is mechanically connected to said lid by jumping automatically into a second position which locks the emergency key, or by being manually moved. The battery compartment lid is usually movable in order to replace the battery or is designed so that it can be pivoted. This movement of the battery compartment lid is used in order to move the battery compartment lid or a locking element which is formed on it between the locking and unlocking position. The locking position of the battery compartment lid here preferably corresponds to the locking position of the emergency key.

Preferably, a jumping movement of the battery compartment lid is provided which creates the locking position of the battery compartment lid and the emergency key. This can ideally be achieved by the battery contact which is for example below the battery, and which advantageously acts as a spring. The battery is in turn pushed by the battery compartment lid onto the battery contact.

The shaft for the emergency key preferably traverses the battery compartment. Here, the emergency key acts as a security against loss for the battery compartment lid, which can be regarded as being an independent invention aspect of this particularly preferred embodiment.

In order to push the key back into the housing after use, the battery lid must be pushed or pivoted back into the home position.

The invention will now be described in greater detail below, by means of exemplary embodiments and with reference to the figures. In the following, elements which are the same and/or which have the same function are assigned the same reference numerals. The individual operating elements and/or the electrical components are not shown in greater detail in the figures, since these are not essential to the invention.

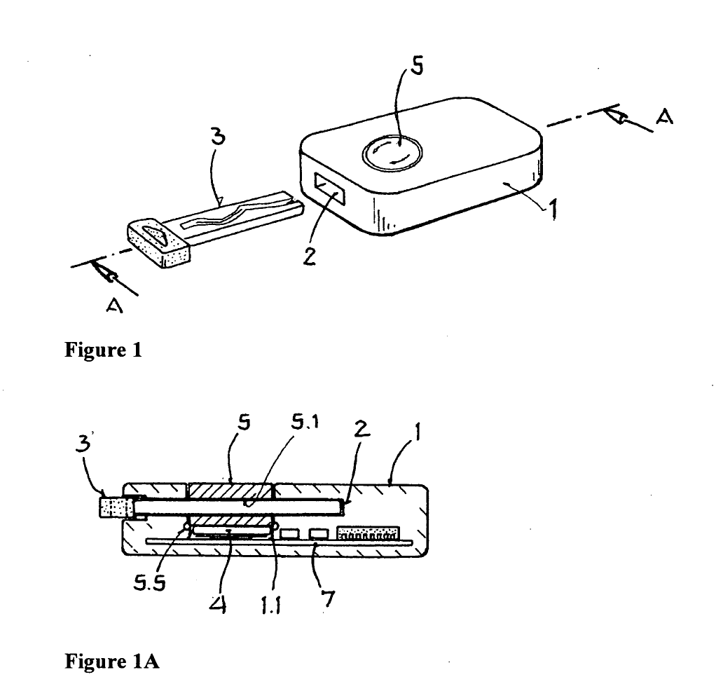

FIG. 1: shows a first exemplary embodiment of the operating unit according to the invention

FIG. 1A: shows a view of a section of the operating unit along the line AA in accordance with FIG. 1

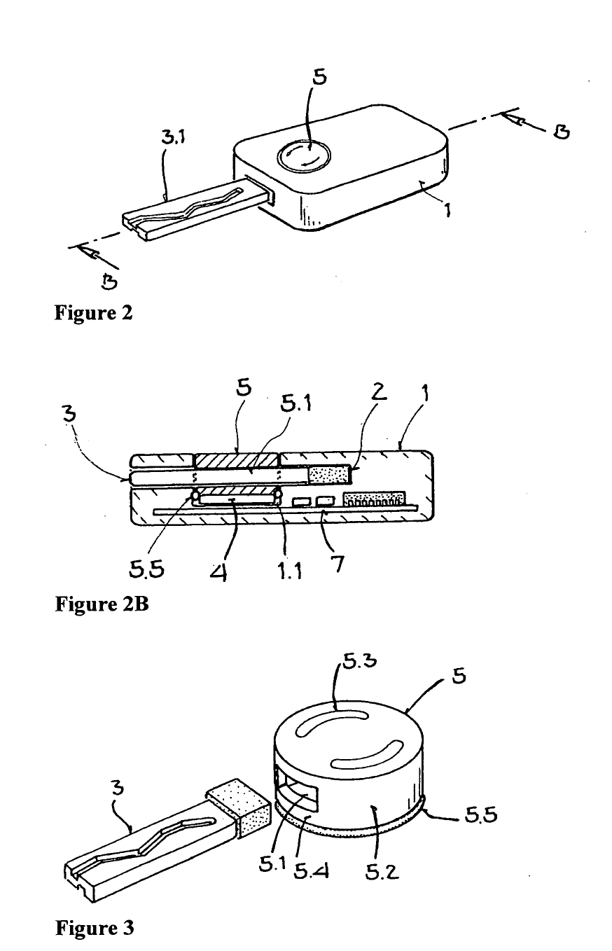

FIG. 2: shows a second exemplary embodiment of the operating unit according to the invention

FIG. 2B: shows a view of a cross-section of the operating unit along the line BB in accordance with FIG. 2

FIG. 3: shows a detailed view of a battery compartment lid of the exemplary embodiments according to FIGS. 1 and 2

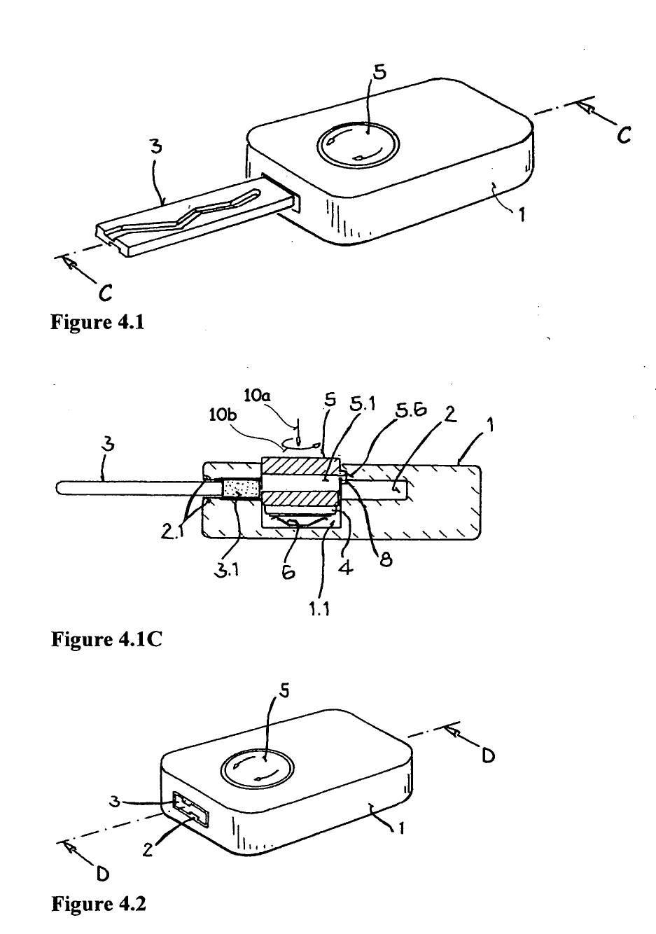

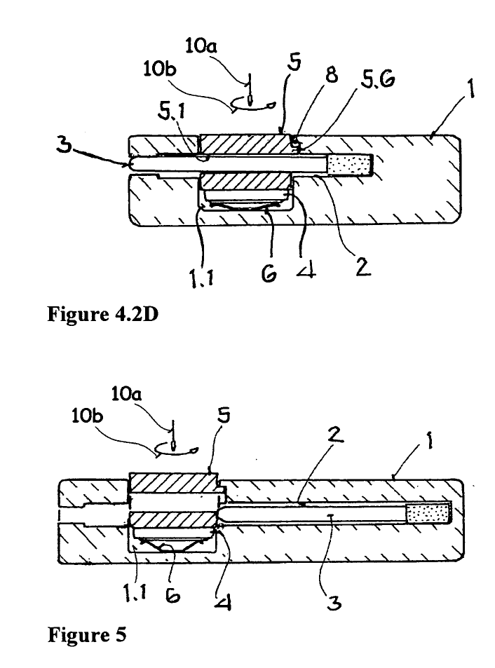

FIG. 4.1: shows a third exemplary embodiment of the operating unit according to the invention, wherein the emergency key is pulled out of the usage position

FIG. 4.1C: shows a view of a cross-section of the operating unit along the line CC according to FIG. 4.1

FIG. 4.2: shows the third exemplary embodiment of the operating unit according to the invention, wherein the emergency key is pushed into the storage position

FIG. 4.2D: shows a view of a cross-section of the operating unit along the line DD according to FIG. 4.2

FIG. 5: shows a continuative embodiment of the third example according to FIGS. 4.1 and 4.2

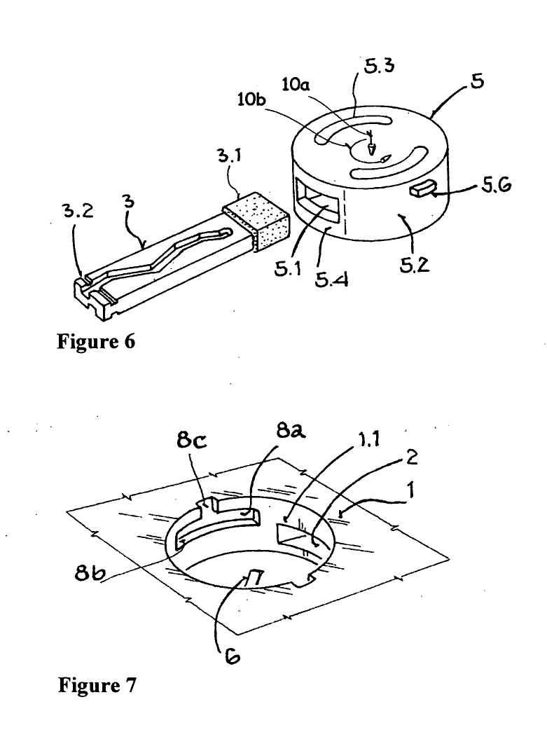

FIG. 6: shows a detailed view of a battery compartment lid of the exemplary embodiments according to FIGS. 4.1 and 4.2

FIG. 7: shows a detailed view of a battery compartment of the exemplary embodiments according to FIGS. 4.1 and 4.2

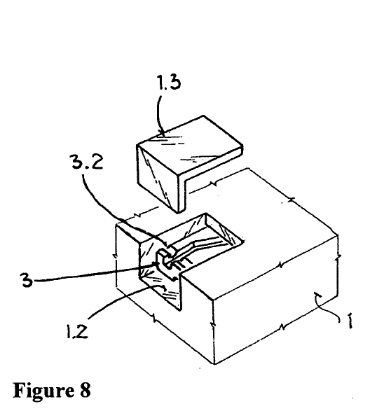

FIG. 8: shows a detailed view of a recess on the housing of the exemplary embodiments according to FIGS. 4.1 and 4.2

FIGS. 1 and 1A show a first exemplary embodiment of an operating unit according to the invention, e.g. of an ignition key of a motor vehicle with an emergency key 3. Here, FIG. 1A shows a view of a cross-section of the operating unit or the housing 1 of the operating unit along the line AA in FIG. 1 in the direction shown by the arrow. In this exemplary embodiment, this operating unit is designed in such a manner that the emergency key 3 can be fully pulled out of the housing 1 of the operating unit during use, as can be seen in FIG. 1.

FIGS. 2 and 2B show a second exemplary embodiment of the operating unit according to the invention. In comparison with the exemplary embodiment shown in FIGS. 1 and 1A, the operating unit according to the invention is designed in this exemplary embodiment in such a manner that only the teeth of the emergency key 3 can be pulled out from the housing 1, rather than the complete key.

The housing 1 of the operating unit according to the invention comprises a recess as a battery compartment 1.1 which is covered by a movable battery compartment lid 2, wherein in said battery compartment 1.1, one or more button cells 4 are inserted, depending on the embodiment. As can be seen in FIGS. 1A and 2B, in the battery compartment 1.1, one battery cell 4 is inserted. This battery cell 4 supplies the electronic components in the printed circuit board 7 which is integrated in said operating unit with electric energy.

According to the invention, the housing 1 of the operating unit comprises a shaft 2 for retaining an emergency key 3, wherein this shaft 2 passes through the battery compartment 1.1. The battery compartment lid 2 comprises an opening 5.1 through which the emergency key 3 can be guided. This opening 5.1 can clearly be seen in FIG. 3.

FIG. 3 shows a detailed view of the battery compartment lid 5 of the operating unit according to the two first exemplary embodiments. The battery compartment lid 5 comprises in both preferred embodiments shown at least one gripping means 5.4 which grips behind the emergency key 3. This gripping means 5.4 can for example be a base plate with a mould which grips the emergency key 5. This gripping means 5.4 ensures that both the emergency key 3 and the battery compartment lid 5, and thus also the battery 4 are secured against loss without additional securing means simply as a result of the mutual locking mechanism. Only when the emergency key 3 is removed can the battery compartment lid 5 also be moved and removed. Due to this embodiment according to the invention and the related avoidance of additional securing means, the operating unit can be produced in an extremely compact and cost-saving manner.

Furthermore, the lower outer edge region of the battery compartment lid 5 is provided with a seal 5.5. The inserted emergency key 3 presses the battery compartment lid 5 against this seal 5.5 and the battery compartment 1.1 and thus ensures that a particularly good seal is provided against humidity penetrating the battery compartment 1.1.

The first two exemplary embodiments comprise an electrical operating unit, in particular an ignition key e.g. for motor vehicles with an emergency key 3, wherein the operating unit is equipped with a battery compartment lid 5, in order to cover the battery 4. In order to prevent the battery lid 5 from opening or springing out as a result of agitation, said lid is according to the invention secured by means of the emergency key 3. The battery compartment lid 5 can only be removed and the battery 4 be changed when the emergency key 3 has been removed from the housing 1 of the operating unit.

The following FIGS. 4 (4.1, 4.1C, 4.2, 4.2D) to 7 show further exemplary embodiments. In these figures, the electrical components together with the printed circuit board 7 are no longer shown in order to simplify the description of the invention. In reality, the operating units according to the invention are equipped with at least one printed circuit board with electrical components.

A third exemplary embodiment of the operating unit according to the invention is shown in FIGS. 4.1, 4.1C, 4.2, 4.2D. The housing 1 of the operating unit according to FIGS. 4.1 and 4.2 also comprises a battery compartment 1.1, which is covered with a lid 5. Furthermore, the housing 1 also comprises according to the invention a shaft 2 for retaining an emergency key 3. As is clearly shown in FIGS. 4.1C and 4.2D, the battery compartment lid 5 is provided with an opening 5.1 which runs through the lid 5 in order to guide through the emergency key 3.

FIGS. 4.1 and 4.1C show the operating unit with the emergency key 3 which has been moved out for use and which is thus located in the usage position 9a. Here, the opening 5.1 is located on the battery compartment lid 5 at a level offset to the opening or the shaft 2 on the housing 1. The bridges 5.2 from the battery compartment lid 5 secure the emergency key 3 against being pushed back into the shaft 2. While the bridges 5.2 are brought by a pivoting movement 10b on the battery compartment lid 5 into the locking position, as an alternative or in addition, the base plate 5.4 of the battery compartment lid 5 can act as a locking element, whereby the battery compartment lid 5 is pushed vertically 10a to the housing 1, or for example is pushed and also pivoted 10a+10b by means of a screwing movement.

The final stop 2.1 at the end of the shaft 2 and the final stop 3.1 on the key 3 together prevent a full removal of the emergency key 4 from the housing 1. This is made clear in FIG. 4.1C. Naturally, the invention is not restricted to this embodiment, but can also be used on control units with a fully removable emergency key.

FIGS. 4.2 and 4.2D show the operating unit with the emergency key 3 which has been pushed into the shaft for storage purposes 9b. In the storage position 9b, the emergency key 3 simultaneously secures the battery compartment lid 5 against loss due to the fact that the emergency key 3 is gripped by the base plate 5.4 which is located on the battery compartment lid 5.

FIG. 5 shows a continuative design of the exemplary embodiment according to FIGS. 4.1 and 4.2. Here, the battery compartment lid 5 and/or the parts 5.2 and 5.4 which are connected to it lock the emergency key 3 in its storage position 9b.

Furthermore, the battery 4 and the battery compartment lid 5 which lies above this battery 4 are pushed by the spring force of the battery spring contact 6 into the position which automatically locks the emergency key 3.

FIGS. 4 to 6, in particular FIG. 6, show on the battery compartment lid 5 a mould 5.6 which protrudes from the bridge 5.2, this mould 5.6 being referred to below as the nose. Accordingly, in FIG. 7, a group of recesses 8a, 8b and 8c are located on the inner wall of the battery compartment 1.1, into which 8a, 8b and 8c the nose 5.6 of the battery compartment lid 5 grips, and can move between said recesses 8a, 8b and 8c. Here, the recess 8a and the nose 5.6 which grips in said recess 8a is used in order to lock the emergency key 3 in the shaft 2 in the storage position 9b, and the recess 8b and the nose 5.6 which grips in said recess 8b is used in order to lock the emergency key 3 in the usage position 9a. Furthermore, the recess 8c and the nose 5.6 which grips in said recess 8c is used to unlock the battery compartment lid 5, and thus to change the battery, wherein the battery lid 5 can be detached by the nose 7 gliding upwards along the unlocking position 8c and out of the recess 8c.

Thus, the emergency key 3 can be locked by a simple lateral 10a or pivoting 10b movement of the battery compartment lid 5 between the usage position 9a and the storage position 9b, and the battery compartment lid 5 and therefore also the battery 4 can be locked or unlocked.

The nose 5.6 is also used to prevent the battery compartment lid 5 from falling off the housing 1 when the emergency key 3 is in the usage position 9a.

FIG. 8 also shows a continuative design of the exemplary embodiments described above. With this design, the gripping means 3.2 is on the emergency key 3 is provided by a recess 1.2 which is set back on the housing 1 of the operating unit, and therefore the emergency key can if required be accessed on the gripping means 3.2 and pulled out of the shaft 2. This recess 1.2 on the housing 1 is covered by a cover 1.3. This cover 1.3 can also secure the emergency key 3 against moving out, in particular when said key 3 is pushed by a spring element 6 from the storage position 9b into the usage position 9a.

### LIST OF REFERENCE NUMERALS

1 Housing of an electric operating unit according to the invention, e.g. of an ignition key
1.1 Battery compartment on housing 1
1.2 Recess on housing 1 for the emergency key 3
1.3 Cover of recess 1.2
2 Shaft for retaining emergency key 3 in housing 1
2.1 Final stop on shaft 2
3 Emergency key of the electrical operating unit according to the invention
3.1 End stop on emergency key 3
3.2 Gripping means on emergency key 3
3.3 Teeth of emergency key 3
4 Battery
5 Battery compartment lid
5.1 Continuous recess in battery compartment lid 5 for guiding through emergency key 3
5.2 Bridges in battery compartment lid 5 for blocking emergency key 3 in usage position 9a
5.3 Gripping means on the upper outer side of battery compartment lid 5 for activating battery compartment lid 5
5.4 Gripping means on floor (on base plate) of battery compartment lid 5 gripping behind emergency key 3
5.5 Seal on battery compartment lid 5 of battery compartment 1.1
5.6 Nose on battery compartment lid 5, so that battery compartment lid 5 does not fall off housing 1 when emergency key 3 is in usage position 9b
6 Battery contact spring element
7 Printed circuit board with electronic components
8 Recesses on the inner wall of battery compartment 1.1 of housing 1 for nose 5.6 on battery compartment lid 5
8a Locking position of battery lid 5 for locking emergency key 3 in storage position 9b
8b Locking position of battery lid 5 for locking emergency key 3 in usage position 9a
8c Unlocking position of battery lid 5 for changing battery 4
9a Usage position of emergency key 3
9b Storage position of emergency key 3
10a Pivoting movement of battery compartment lid 5 against housing 1
10b Vertical movement of battery compartment lid 5 against housing 1
10a+10b Screwing movement of battery compartment lid 5 against housing 1, wherein battery compartment lid 5 is both vertically displaced and pivoted against housing 1

1. An electrical operating unit for a motor vehicle, wherein said operating unit comprises
a shaft for retaining an emergency key
a battery compartment
a movable battery compartment lid, and
a locking element for locking the emergency key
wherein the emergency key is movably arranged in the shaft between a storage position and a usage position
characterized in that
the shaft passes through the battery compartment, wherein the battery compartment lid comprises an opening for guiding through the emergency key.

2. An operating unit according to claim 1,
characterized in that
the battery compartment lid comprises at least one element which grips behind the emergency key.

3-14. (canceled)

15. An operating unit according to claim 1,
characterized in that
between the battery compartment and the battery compartment lid, a seal is arranged, wherein the battery compartment lid is pressed against said seal and against the battery compartment.

16. An operating unit according to claim 1,
characterized in that
as a locking element, the battery compartment lid itself or a locking element which is mechanically connected with it is provided, and the battery compartment lid is movable into a position in which the emergency key can be locked.

17. An operating unit according to claim 1,
characterized in that
a spring mechanism is provided which automatically moves the battery compartment lid into a position which locks the emergency key.

18. An operating unit according to claim 17,
characterized in that
the spring mechanism is formed by a spring elastic battery contact element, wherein at least one part of the spring elastic battery contact element acts directly on the battery compartment lid or on a part which is mechanically connected to the battery compartment lid, in particular the locking element or the battery.

19. An operating unit according to claim 1,
characterized in that
the locking position of the battery compartment lid corresponds to the locking position of the emergency key.

20. An operating unit according to claim 1,
characterized in that
a first locking position of the battery compartment lid is provided for locking the battery compartment lid when the emergency key is in the storage position, and a second locking position is provided which deviates from the first, in which on the one hand the battery compartment lid is locked in the operating unit, and on the other, the emergency key in the usage position is locked against being pushed back into the shaft.

21. An operating unit according to claim 1,
characterized in that
on the battery compartment lid, a securing element is provided which secures the battery compartment lid on the operating unit when the emergency key is in the usage position.

22. An operating unit according to claim 1,
characterized in that
a gripping means is provided on the emergency key, on which the emergency key can be pulled out of the shaft.

23. An operating unit according to claim 22,
characterized in that
a movable cover is provided on the operating unit which covers the gripping means in a covering position, and which is movable into an access position in which the gripping means can be gripped.

24. An operating unit according to claim 1,
characterized in that
on the shaft of the operating unit or on the emergency key, at least one stop means is provided, wherein by means of this stop means, a complete removal of the emergency key from the operating unit is prevented.

25. An operating unit according to claim 1,
characterized in that
a spring element is provided in the shaft which pushes the emergency key in the direction of the usage position.

26. An operating unit according to claim 1,
characterized in that
the emergency key can be locked in the storage position in the shaft by the battery compartment lid itself or by the locking element which is mechanically connected to it.
